(19) United States
(12) Patent Application Publication
(10) Pub. No.: US 2022/0364875 A1
(43) Pub. Date: Nov. 17, 2022

(54) METHOD, INFORMATION PROCESSING DEVICE, AND NON-TRANSITORY STORAGE MEDIUM STORING PROGRAM

(71) Applicant: TOYOTA JIDOSHA KABUSHIKI KAISHA, Toyota-shi (JP)

(72) Inventors: Atsushi OKUBO, Toyota-shi (JP); Kento NITTA, Tokyo (JP); Takaaki KATO, Saitama-shi (JP); Daiki KANEICHI, Tokyo (JP); Minoru NAKADORI, Nagoya-shi (JP)

(21) Appl. No.: 17/660,228

(22) Filed: Apr. 22, 2022

(30) Foreign Application Priority Data
May 14, 2021 (JP) 2021-082682

(51) Int. Cl. G01C 21/36; G01C 21/34

(52) U.S. Cl. CPC G01C 21/3617; G01C 21/3484; G01C 21/3461; G01C 21/3691

(57) ABSTRACT

A method executed by an information processing device includes acquiring first information indicating use records of a user for each of a plurality of transportations, acquiring second information indicating preference levels of the user for each of the transportations, and outputting third information suggesting the user to use at least one transportation among the transportations, based on the first information and the second information.

### CROSS-REFERENCE TO RELATED APPLICATION

This application claims priority to Japanese Patent Application No. 2021-082682 filed on May 14, 2021, incorporated herein by reference in its entirety.

### BACKGROUND

### 1. Technical Field

The present disclosure relates to a method, an information processing device, and a non-transitory storage medium storing a program.

### 2. Description of Related Art

In the related art, technology for encouraging users to use transportations, such as an automobile is known. For example, Japanese Unexamined Patent Application Publication No. 2018-081022 (JP 2018-081022 A) discloses that users are encouraged to use a park and ride in which users move with the automobiles from a departure point to a parking lot around a train station or a bus stop, park the automobiles in the parking lot, and thereafter go to a destination by using the public transportation system, such as a rail system or bus.

### SUMMARY

There are some points that need to be improved in the technology for encouraging users to use transportations.

The present disclosure is to provide a method of improving the technology for encouraging users to use transportations.

A first aspect of the present disclosure relates to a method executed by an information processing device. The method includes acquiring first information indicating use records of a user for each of a plurality of transportations, acquiring second information indicating preference levels of the user for each of the transportations, and outputting third information suggesting the user to use at least one transportation among the transportations, based on the first information and the second information.

The method according to the first aspect may further include acquiring the second information by estimating the preference levels of the user for each of the transportations based on the use records of the user for each of the transportations.

The method according to the first aspect may further include estimating the preference levels of the user for each of the transportations by using a machine learning model for outputting output data including the second information when input data including the first information is input.

The method according to the first aspect may further include outputting, as the third information, information suggesting the user to use at least one transportation that is selected from the transportations based on the first information and the second information and satisfies at least one of a first condition and a second condition, in which the first condition may be a condition that the number of times of use or a frequency of use by the user in the past is less than a first threshold value, and the second condition may be a condition that the preference level of the user is equal to or higher than a second threshold value.

The method according to the first aspect may further include outputting, as the third information, information suggesting the user to use at least one transportation that satisfies both the first condition and the second condition.

The method according to the first aspect may further include acquiring fourth information in which weather conditions are associated with each of two or more transportations, acquiring weather information indicating a present weather or a future weather, and as the transportations, specifying a plurality of transportations for which the weather conditions associated in the fourth information are satisfied in the present or future, from the two or more transportations.

In the method according to the first aspect, the weather conditions, which are associated with each of the two or more transportations in the fourth information, may indicate weather conditions in which a demand for a corresponding transportation is high in light of a predetermined reference.

A second aspect of the present disclosure relates to an information processing device. The information processing device is an information processing device including a controller, in which the controller is configured to acquire first information indicating use records of a user for each of a plurality of transportations, acquire second information indicating preference levels of the user for each of the transportations, and output third information suggesting the user to use at least one transportation among the transportations, based on the first information and the second information.

In the information processing device according to the second aspect, the controller may be configured to acquire the second information by estimating the preference levels of the user for each of the transportations based on the use records of the user for each of the transportations.

In the information processing device according to the second aspect, the controller may be configured to estimate the preference levels of the user for each of the transportations by using a machine learning model for outputting output data including the second information when input data including the first information is input.

In the information processing device according to the second aspect, the controller may be configured to output, as the third information, information suggesting the user to use at least one transportation that is selected from the transportations based on the first information and the second information and satisfies at least one of a first condition and a second condition.

The first condition may be a condition that the number of times of use or a frequency of use by the user in the past is less than a first threshold value, and the second condition may be a condition that the preference level of the user is equal to or higher than a second threshold value.

In the information processing device according to the second aspect, the controller may be configured to output, as the third information, information suggesting the user to use at least one transportation that satisfies both the first condition and the second condition.

In the information processing device according to the second aspect, the controller may be configured to acquire fourth information in which weather conditions are associated with each of two or more transportations, acquire weather information indicating a present weather or a future weather, and as the transportations, specify a plurality of transportations for which the weather conditions associated in the fourth information are satisfied in the present or future, from the two or more transportations.

In the information processing device according to the second aspect, the weather conditions, which are associated with each of the two or more transportations in the fourth information, may indicate weather conditions in which a demand for a corresponding transportation is high in light of a predetermined reference.

A third aspect of the present disclosure relates to a non-transitory storage medium storing a program. The non-transitory storage medium storing the program that causes a computer to execute acquiring first information indicating use records of a user for each of a plurality of transportations, acquiring second information indicating preference levels of the user for each of the transportations, and outputting third information suggesting the user to use at least one transportation among the transportations, based on the first information and the second information.

In the storage medium according to the third aspect, the program may cause the computer to further execute acquiring the second information by estimating the preference levels of the user for each of the transportations based on the use records of the user for each of the transportations.

In the storage medium according to the third aspect, the program may cause the computer to further execute estimating the preference levels of the user for each of the transportations by using a machine learning model for outputting output data including the second information when input data including the first information is input.

In the storage medium according to the third aspect, the program may cause the computer to further execute outputting, as the third information, information suggesting the user to use at least one transportation that is selected from the transportations based on the first information and the second information and satisfies at least one of a first condition and a second condition.

The first condition may be a condition that the number of times of use or a frequency of use by the user in the past is less than a first threshold value, and the second condition may be a condition that the preference level of the user is equal to or higher than a second threshold value.

In the storage medium according to the third aspect, the program may cause the computer to further execute acquiring fourth information in which weather conditions are associated with each of two or more transportations, acquiring weather information indicating a present weather or a future weather, and as the transportations, specifying a plurality of transportations for which the weather conditions associated in the fourth information are satisfied in the present or future, from the two or more transportations.

In the storage medium according to the third aspect, the weather conditions, which are associated with each of the two or more transportations in the fourth information, may indicate weather conditions in which a demand for a corresponding transportation is high in light of a predetermined reference.

According to each aspect of the present disclosure, it is possible to improve the technology for encouraging users to use transportations.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a schematic configuration of a system according to an embodiment of the present disclosure;

FIG. 2 is a block diagram showing a schematic configuration of a terminal device;

FIG. 3 is a block diagram showing a schematic configuration of an information processing device; and

FIG. 4 is a flowchart showing an operation of the information processing device.

### DETAILED DESCRIPTION OF EMBODIMENTS

Hereinafter, an embodiment of the present disclosure will be described.

Overview of Embodiment

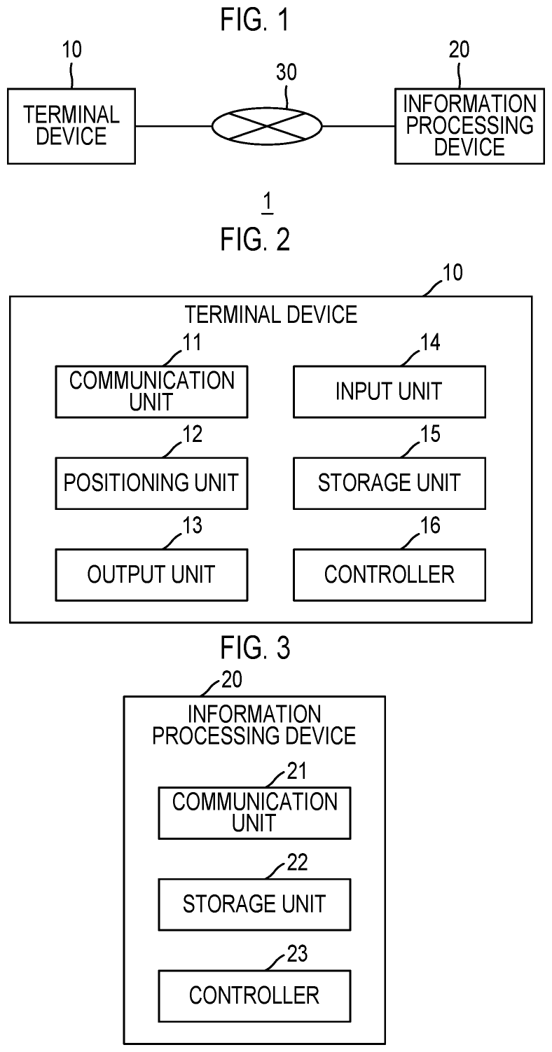

An overview of a system 1 according to the embodiment of the present disclosure will be described with reference to FIG. 1. The system 1 includes a terminal device 10 and an information processing device 20. The terminal device 10 and the information processing device 20 are communicably connected to a network 30 including, for example, the Internet and a mobile communication network.

The terminal device 10 is any computer used by a user. For example, a general-purpose computer, such as a smartphone or a tablet terminal, or a dedicated computer can be employed as the terminal device 10.

The information processing device 20 is, for example, a server device but is not limited to this and may be any computer. The information processing device 20 is capable of communicating with the terminal device 10 via the network 30.

First, the overview of the present embodiment will be described, and the details will be described later. The information processing device 20 acquires information (hereinafter, also referred to as “first information”) indicating use records of the user for each of a plurality of transportations. The information processing device 20 acquires information (hereinafter, also referred to as “second information”) indicating preference levels of the user for each of the transportations. Thereafter, the information processing device 20 outputs information (hereinafter, also referred to as “third information”) of suggesting the user to use at least one transportation among the transportations, based on the first information and the second information.

As described above, according to the present embodiment, an added value can be provided to the transportation experience of the user by making a suggestion that takes into consideration the use records and the preference levels of the user for each of the transportations, such as a bus, a taxi, and a shared car. For example, when there is the use record of the user and the suggestion is made to use a transportation with a high preference level, it is possible to provide a highly satisfying transportation experience for the user. Further, for example, when there is no use record of the user and the suggestion is made to use a transportation with a high preference level, it is possible to provide a new transportation experience for the user. Therefore, the technology for encouraging users to use transportations is improved in that it is possible to make a suggestion to use a transportation providing an added value to a transportation experience of a user.

Next, each configuration of the system 1 will be described in detail.

Configuration of Terminal Device

As shown in FIG. 2, the terminal device 10 includes a communication unit 11, a positioning unit 12, an output unit 13, an input unit 14, a storage unit 15, and a controller 16.

The communication unit 11 includes one or more communication interfaces connected to a network 30. The communication interface corresponds to, for example, a mobile communication standard, such as 4th generation (4G) or 5th generation (5G), a wired local area network (LAN) standard, a wireless LAN standard but is not limited to these and may correspond to any communication standard. In the present embodiment, the terminal device 10 communicates with the information processing device 20 via the communication unit 11 and the network 30.

The positioning unit 12 includes one or more devices that acquire position information of the terminal device 10. Specifically, the positioning unit 12 includes, for example, a receiver corresponding to GPS but is not limited to this and may include a receiver corresponding to any satellite positioning system. When the terminal device 10 is a mobile terminal portable by the user, the position information of the terminal device 10 may be treated as position information of the user.

The output unit 13 may include one or more output devices that output information and notify the user of the information. Examples of the output device include a display that outputs information as a video and a speaker that outputs information as an audio, but the output device is not limited to these. The output unit 13 may include an interface for connecting an external output device.

The input unit 14 may include one or more input devices that detect a user input. Examples of the input device include a physical key, a capacitance key, a touch screen integrally provided with a display, a microphone that receives a voice input, and a camera, but the input device is not limited to these. The input unit 14 may include an interface for connecting an external input device.

The storage unit 15 includes one or more memories. Examples of the memory include a semiconductor memory, a magnetic memory, and an optical memory, but the memory is not limited to these. Each memory included in the storage unit 15 may function as, for example, a main storage device, an auxiliary storage device, or a cache memory. The storage unit 15 stores any information used for an operation of the terminal device 10. For example, the storage unit 15 may store a system program, an application program, or embedded software. The information stored in the storage unit 15 may be capable of updating with information acquired from the network 30 via, for example, the communication unit 11.

The controller 16 includes one or more processors, one or more programmable circuits, one or more dedicated circuits, or a combination thereof. The processor is, for example, a general-purpose processor, such as a central processing unit (CPU) or a graphics processing unit (GPU), or a dedicated processor specialized for a specific process, but is not limited to these. The programmable circuit is, for example, a field-programmable gate array (FPGA), but is not limited to this. The dedicated circuit is, for example, an application specific integrated circuit (ASIC), but is not limited to this. The controller 16 controls the operation of the entire terminal device 10.

Configuration of Information Processing Device

As shown in FIG. 3, the information processing device 20 includes a communication unit 21, a storage unit 22, and a controller 23.

The communication unit 21 includes one or more communication interfaces connected to the network 30. The communication interface corresponds to, for example, a mobile communication standard, a wired LAN standard, or a wireless LAN standard but is not limited to these and may correspond to any communication standard. In the present embodiment, the information processing device 20 communicates with the terminal device 10 via the communication unit 21 and the network 30.

The storage unit 22 includes one or more memories. Each memory included in the storage unit 22 may function as, for example, a main storage device, an auxiliary storage device, or a cache memory. The storage unit 22 stores any information used for an operation of the information processing device 20. For example, the storage unit 22 may store a system program, an application program, a database, or map information. The information stored in the storage unit 22 may be capable of updating with information acquired from the network 30 via, for example, the communication unit 21.

The controller 23 includes one or more processors, one or more programmable circuits, one or more dedicated circuits, or a combination thereof. The controller 23 controls the operation of the entire information processing device 20.

Operation Flow of Information Processing Device

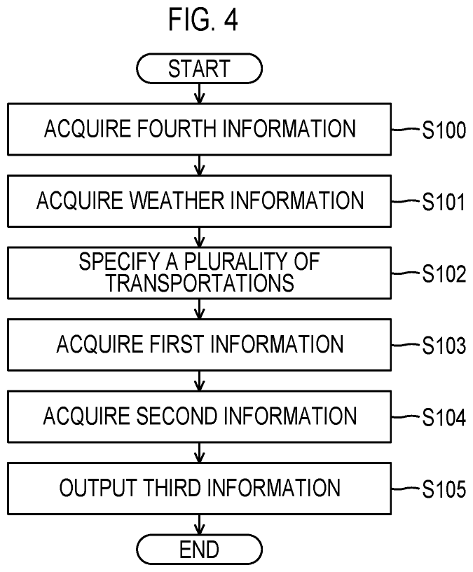

The operation of the information processing device 20 according to the present embodiment will be described with reference to FIG. 4.

Step S100: The controller 23 of the information processing device 20 acquires information (hereinafter, also referred to as “fourth information”) in which weather conditions are associated with each of two or more transportations.

Each of the two or more transportations is provided by, for example, the public transportation system or a rental company, but the present disclosure is not limited to this, and the user may own one or more transportations. The present embodiment is described with an assumption that the two or more transportations are a bus, a taxi, a shared car, a bicycle, a motorcycle, and a Segway, as specific examples.

The weather conditions associated with each of the transportations in the fourth information indicate weather conditions in which a demand for the corresponding transportation is high in light of a predetermined reference. For example, bicycles, motorcycles, and Segways do not have a structure that blocks rain, so demand can be higher on sunny days than on rainy days. Therefore, the weather condition of “sunny” may be associated with each of the bicycle, motorcycle, and Segway.

People who use bicycles, motorcycles, or Segways on sunny days may use buses, taxis, or shared cars as the alternative transportations on rainy days. Accordingly, buses, taxis, and shared cars can be in higher demand on rainy days than on sunny days. Therefore, the weather condition of “rain” may be associated with each of the bus, taxi, and shared car.

The weather conditions associated with each of the transportations in the fourth information are not limited to “rain” or “sunny”, and may be any weather conditions, such as temperature or humidity. The weather conditions associated with each of the transportations in the fourth information may be automatically determined, for example, by statistical processing using past demand data and weather data of each of the transportations or may be specified by an operator.

Step S101: The controller 23 acquires weather information indicating the present or future weather.

Specifically, the controller 23 acquires the weather information by receiving the weather information from an external server via the communication unit 21 and the network 30. However, the controller 23 may acquire the weather information by any method, not limited to the above example.

Step S102: The controller 23 specifies a plurality of transportations for which the weather conditions associated in the fourth information are satisfied in the present or future, from the two or more transportations, which is acquired in step S100.

The present embodiment is described with an assumption that the present or future weather indicated in the weather information acquired in step S101 is “rain”, and the bus, taxi, and shared car, in which the weather condition of “rain” is associated in the fourth information, are specified.

Step S103: The controller 23 acquires first information indicating use records of the user for each of the transportations specified in step S102 (hereinafter, also simply referred to as “the transportations”).

The use record is expressed by, for example, a numerical value representing the number of times of use or a frequency of use by the user in the past but is not limited to these and may be expressed by any index representing a use record, such as a grade. The number of times of use may be the number of times the user used the transportations during the entire period or a certain period of time in the past. The frequency of use may be a ratio of the number of times of use in the transportations. When the number of times of use for a transportation is zero, a frequency of use for the transportation may be set to zero.

Any method can be employed for acquiring the first information. For example, the controller 16 of the terminal device 10 may store the use record of the user for the transportation in the storage unit 15 every time the user uses a transportation, for example. In the above case, the controller 23 of the information processing device 20 may acquire the first information by receiving the first information indicating the use records of the user for each of the transportations specified in step S102 from the terminal device 10 via the communication unit 21 and the network 30. Alternatively, the controller 23 may receive data of the use records of the user for each of the transportations from a computer of a company providing each of the transportations specified in step S102 via the communication unit 21 and the network 30 and integrates each received data to acquire as the first information.

The present embodiment is described with an assumption that the first information indicating the use records of the user for each of the bus, taxi, and shared car specified in step S102 is acquired.

Step S104: The controller 23 acquires second information indicating preference levels of the user for each of the transportations.

The preference level is indicated by, for example, a natural number of 1 or more and 10 or less but is not limited to this and may be indicated by any index representing the degree of preference, such as a grade. Any method can be employed for acquiring the second information.

For example, the controller 23 may acquire the second information by estimating the preference levels of the user for each of the transportations based on the use records of the user for each of the transportations. Specifically, the controller 23 may estimate the preference levels of the user for each of the transportations by using, for example, a machine learning model for outputting output data including the second information when input data including the first information is input. Specifically, the controller 23 inputs the first information acquired in step S103 into the machine learning model and acquires the second information from the output data output from the machine learning model. As the machine learning model, for example, a model that is trained by using the use records, as learning data, for each of the transportations by a large number of users can be employed. However, the estimation of the preference level is not limited to the example using the machine learning model, and any method can be employed. For example, a method of estimating a preference level of a desired user for a desired transportation may be employed based on the result of the statistical processing of the use records for each of the transportations by a large number of users.

Alternatively, the controller 23 may acquire the second information by receiving the second information previously input to the terminal device 10 by the user from the terminal device 10 via the communication unit 21 and the network 30.

The present embodiment is described with an assumption that the second information indicating the preference levels of the user for each of the bus, taxi, and shared car specified in step S102 is acquired.

Step S105: The controller 23 outputs third information suggesting the user to use at least one transportation among the transportations, based on the first information and the second information.

Specifically, the controller 23 selects at least one transportation among the transportations satisfying at least one of a first condition and a second condition, based on the first information and the second information. The first condition may be a condition that the number of times of use or a frequency of use by the user in the past is less than a first threshold value (for example, less than 1). The second condition may be a condition that the preference level of the user is equal to or higher than a second threshold value (for example, equal to or higher than 5).

The specific examples of the use records (the number of times of use or the frequency of use) and the preference levels for the three transportations of the bus, taxi, and shared car specified in step S102 as described above, are shown in a table below.

TABLE 1

| | Bus | Taxi | Shared car |
|---|---|---|---|
| Use record | 10 | 7 | 0 |
| Preference level | 4 | 8 | 6 |

In the specific example shown in the above table, the taxi and the shared car satisfy the first condition, and the shared car satisfies the second condition. Therefore, at least one of the taxi and the shared car may be selected. In the present embodiment, at least one transportation that satisfies both the first condition and the second condition is selected. In the above case, the shared car that satisfies the first condition and the second condition is selected.

The first condition is not limited to the above-mentioned example and may be determined by using any examples. For example, the first condition may be a condition that the number of times of use or the use record by the user in the past is equal to or larger than a predetermined threshold value.

The controller 23 outputs information suggesting the user to use at least one selected transportation as the third information and transmits the information to the terminal device 10 via the communication unit 21 and the network 30. The controller 16 of the terminal device 10 notifies the user of the third information received from the information processing device 20 via the output unit 13.

As described above, the information processing device 20 according to the present embodiment acquires the first information indicating the use records of the user for each of the transportations. The information processing device 20 acquires the second information indicating the preference levels of the user for each of the transportations. Thereafter, the information processing device 20 outputs the third information suggesting the user to use at least one transportation among the transportations based on the first information and the second information.

According to the above configuration, an added value can be provided to the transportation experience of the user by making a suggestion that takes into consideration the use records and the preference levels of the user for each of the transportations, such as a bus, a taxi, and a shared car. For example, when there is the use record of the user and the suggestion is made to use a transportation with a high preference level, it is possible to provide a highly satisfying transportation experience for the user. Further, for example, when there is no use record of the user and the suggestion is made to use a transportation with a high preference level, it is possible to provide a new transportation experience for the user. Therefore, the technology for encouraging users to use transportations is improved in that it is possible to make a suggestion to use a transportation providing an added value to a transportation experience of a user.

Although the present disclosure has been described based on the drawings and examples, it should be noted that those skilled in the art may make various modifications and changes based on the present disclosure. Therefore, these modifications and changes are within the scope of the present disclosure. For example, the functions included in each component or each step can be rearranged so as not to be logically inconsistent, and a plurality of components or steps can be combined or divided into one.

For example, in the above-described embodiment, the configuration and operation of the information processing device 20 may be distributed to a plurality of computers capable of communicating with each other. Further, an embodiment in which a part or all the components of the information processing device 20 are provided in the terminal device 10 is also possible.

For example, in the above-described embodiment, the operation flow of the information processing device 20 is described separately in steps S100 to S105. However, an embodiment in which some steps are omitted is also possible. For example, the operation of steps S100 to S102 may be omitted. In the above case, the controller 23 of the information processing device 20 executes the operations of steps S103 to S105 by using the transportations set in advance as a target.

Further, for example, an embodiment in which a general-purpose computer is caused to function as the information processing device 20 according to the above-described embodiment is also possible. Specifically, a program, in which the processing content for implementing each function of the information processing device 20 according to the above-described embodiment is written, is stored in a memory of a general-purpose computer, and the program is read and executed by a processor of the computer. Therefore, the present disclosure can also be achieved as a program that can be executed by a processor or a non-transitory computer-readable medium that stores the program.

What is claimed is:

1. A method executed by an information processing device, the method comprising:
acquiring first information indicating use records of a user for each of a plurality of transportations;
acquiring second information indicating preference levels of the user for each of the transportations; and
outputting third information suggesting the user to use at least one transportation among the transportations, based on the first information and the second information.

2. The method according to claim 1, further comprising acquiring the second information by estimating the preference levels of the user for each of the transportations based on the use records of the user for each of the transportations.

3. The method according to claim 2, further comprising estimating the preference levels of the user for each of the transportations by using a machine learning model for outputting output data including the second information when input data including the first information is input.

4. The method according to claim 1, further comprising outputting, as the third information, information suggesting the user to use at least one transportation that is selected from the transportations based on the first information and the second information and satisfies at least one of a first condition and a second condition, wherein:
the first condition is a condition that the number of times of use or a frequency of use by the user in the past is less than a first threshold value; and
the second condition is a condition that the preference level of the user is equal to or higher than a second threshold value.

5. The method according to claim 4, further comprising outputting, as the third information, information suggesting the user to use at least one transportation that satisfies both the first condition and the second condition.

6. The method according to claim 1, further comprising:
acquiring fourth information in which weather conditions are associated with each of two or more transportations;
acquiring weather information indicating a present weather or a future weather; and
as the transportations, specifying a plurality of transportations for which the weather conditions associated in the fourth information are satisfied in the present or future, from the two or more transportations.

7. The method according to claim 6, wherein the weather conditions, which are associated with each of the two or more transportations in the fourth information, indicate weather conditions in which a demand for a corresponding transportation is high in light of a predetermined reference.

8. An information processing device comprising a controller,
wherein the controller is configured to
acquire first information indicating use records of a user for each of a plurality of transportations,
acquire second information indicating preference levels of the user for each of the transportations, and
output third information suggesting the user to use at least one transportation among the transportations, based on the first information and the second information.

9. The information processing device according to claim 8, wherein the controller is configured to acquire the second information by estimating the preference levels of the user for each of the transportations based on the use records of the user for each of the transportations.

10. The information processing device according to claim 9, wherein the controller is configured to estimate the preference levels of the user for each of the transportations by using a machine learning model for outputting output data including the second information when input data including the first information is input.

11. The information processing device according to claim 8, wherein:
the controller is configured to output, as the third information, information suggesting the user to use at least one transportation that is selected from the transportations based on the first information and the second information and satisfies at least one of a first condition and a second condition;
the first condition is a condition that the number of times of use or a frequency of use by the user in the past is less than a first threshold value; and
the second condition is a condition that the preference level of the user is equal to or higher than a second threshold value.

12. The information processing device according to claim 11, wherein the controller is configured to output, as the third information, information suggesting the user to use at least one transportation that satisfies both the first condition and the second condition.

13. The information processing device according to claim 8, wherein the controller is configured to,
acquire fourth information in which weather conditions are associated with each of two or more transportations,
acquire weather information indicating a present weather or a future weather, and
as the transportations, specify a plurality of transportations for which the weather conditions associated in the fourth information are satisfied in the present or future, from the two or more transportations.

14. The information processing device according to claim 13, wherein the weather conditions, which are associated with each of the two or more transportations in the fourth information, indicate weather conditions in which a demand for a corresponding transportation is high in light of a predetermined reference.

15. A non-transitory storage medium storing a program that causes a computer to execute:
acquiring first information indicating use records of a user for each of a plurality of transportations;
acquiring second information indicating preference levels of the user for each of the transportations; and
outputting third information suggesting the user to use at least one transportation among the transportations, based on the first information and the second information.

16. The storage medium according to claim 15, wherein the program causes the computer to further execute acquiring the second information by estimating the preference levels of the user for each of the transportations based on the use records of the user for each of the transportations.

17. The storage medium according to claim 16, wherein the program causes the computer to further execute estimating the preference levels of the user for each of the transportations by using a machine learning model for outputting output data including the second information when input data including the first information is input.

18. The storage medium according to claim 15, wherein:
the program causes the computer to further execute outputting, as the third information, information suggesting the user to use at least one transportation that is selected from the transportations based on the first information and the second information and satisfies at least one of a first condition and a second condition;
the first condition is a condition that the number of times of use or a frequency of use by the user in the past is less than a first threshold value; and
the second condition is a condition that the preference level of the user is equal to or higher than a second threshold value.

19. The storage medium according to claim 15, wherein the program causes the computer to further execute
acquiring fourth information in which weather conditions are associated with each of two or more transportations,
acquiring weather information indicating a present weather or a future weather, and
as the transportations, specifying a plurality of transportations for which the weather conditions associated in the fourth information are satisfied in the present or future, from the two or more transportations.

20. The storage medium according to claim 19, wherein the weather conditions, which are associated with each of the two or more transportations in the fourth information, indicate weather conditions in which a demand for a corresponding transportation is high in light of a predetermined reference.
